(19) United States
(12) Patent Application Publication
(10) Pub. No.: US 2006/0037445 A1
(43) Pub. Date: Feb. 23, 2006

(54) Circular saw with laser and protractor

(76) Inventors: Oleksiy P. Sergyeyenko, Brockville (CA); James D. Marshall, Mallorytown (CA); Darko Stjepanovic, Etobicoke (CA)

Correspondence Address: Jonathan Yun;Black & Decker Corporation, Mail Stop TW199, 701 E. Joppa Rd, Towson, MD, 21286, US

(21) Appl. No.: 10/920,593

(22) Filed: Aug. 18, 2004

(51) Int. Cl. B27B 9/00; B26D 7/00

(52) U.S. Cl. 83/13; 83/520; 30/390

(57) ABSTRACT

A laser marker 28 includes fixed legs 64 and 66, and a retractable leg 76, extending therefrom. With legs 64, 66 and 76 extended, the laser marker 28 can be moved about a workpiece surface 124 to selectively locate the line mark 137. With the leg 76 retracted, the legs 64 and 66 can be moved along, a workpiece edge surface 140 to selectively locate the line mark 137. The laser marker 28 can be positioned precisely on a circular saw shoe 150 by placing the legs 64 and 66 within reference holes 180 and 182 on a platform 164 on the shoe. The laser marker 28 can be positioned precisely on a protractor platform 244 by locating the legs 64 and 66 in a first circular guide track and the leg 76 in a second circular guide track 111.

### BACKGROUND OF THE INVENTION

This invention relates to a laser marker, a circular saw with a laser marker, a protractor, and a protractor with a laser marker. In particular, this invention relates to a stand-alone laser marker used for producing a line mark, for example, on a workpiece, to a circular saw with a laser marker mounted thereon for producing a line mark on a workpiece, to a protractor for facilitating the location of placement of a line mark with an angular relationship to a reference, and to a protractor with a laser marker mounted thereon for producing a line mark on a workpiece.

In the construction industry, as well as other industries, laser markers have been used as an accessory which includes a laser for generating a laser beam. The beam can serve as a line mark for use in such diverse processes as guiding, aligning, leveling, locating various construction elements, such as, for example, studs within a wall, accurately performing a work process, such as, for example, cutting a workpiece, and the like.

Some laser markers include only a laser mounted within a barrel in such a manner that a laser beam is projected from an open end of the barrel. Laser markers of this type rely on the barrel to protect and shield the laser. Other types of laser markers include a plastic housing, in which the laser is mounted within the barrel, which is located within the housing.

Laser markers are frequently used in a construction environment where the markers are subjected to unintentional abuse as a result of the manner in which the laser markers are used and stored. The factory-tuned mounting of the laser within the barrel, and further within the housing, is critically necessary to sustain maximum and accurate projection of the laser beam in the intended manner. When the laser marker is subjected to abuse, the laser tends to become dislodged from its factory-tuned mounting to the extent that the integrity of the projected beam is lessened.

Thus, there is a need for a protective and sturdy housing of a laser marker for maintaining a factory-tuned mounting of a laser, within the laser marker.

A first type of laser marker is formed with structure which facilitates the movement of the laser marker over a surface of a structure to a desired location on the surface to provide a line mark on the surface, with respect to a reference point on the surface. Examples of such structures include a workpiece, a wall, any object having a surface onto which a line mark is to be placed, and the like, all hereinafter referred to as a workpiece. Laser markers of this type are not capable of projecting an accurate and desired line mark on the workpiece surface, with respect to a reference point on an edge of the workpiece.

A second type of laser marker is formed with structure which facilitates the guiding of the laser marker along an edge of the workpiece to provide a line mark on the workpiece surface, with respect to a reference point on the workpiece edge. Laser markers of the second type are not capable of projecting an accurate and desired line mark on the workpiece surface, with respect to a reference point on the workpiece surface.

Thus, there is a need for a versatile laser marker which can project accurately a line mark onto a surface of a workpiece with respect to a reference point either on the surface or on an edge of the workpiece.

In another use of a laser marker, a laser barrel, which contains a laser, is mounted on a tool for facilitating the guidance of the tool during a work procedure. For example, a slender laser barrel, with a laser contained therein, is mounted on a safety shield of a circular saw for generating a line mark on a workpiece during a cutting operation. During operation of the circular saw, and during a cutting operation by use of the circular saw, the shield, as well as some of the other elements of the circular, tends to vibrate. Due to the slender structure of the barrel, and the manner of mounting the barrel on the shield, the laser marker tends to vibrate also. With such an arrangement, the mounting of the laser barrel could destabilize due to vibrations of the shield, thereby distorting or misaligning the generated laser beam, which results in unsatisfactory integrity and placement of the line mark generated by the laser.

In addition, the slender laser barrel is rigidly mounted on the shield of the circular saw, which requires time-consuming efforts to mount the laser on, and dismount the laser from, the circular saw.

Thus, there is a need for a laser marker which is formed with substantial supporting structure and is located on a tool in such a manner to provide a stabilized mounting, and which facilitates rapid assembly of the laser marker with, and rapid disassembly of the laser marker from, the tool.

During a construction project, where a cut is to be formed in a workpiece at an angle with respect to a reference such as, for example, an edge, or a reference point on a work surface, of the workpiece, placement of a line mark on the work surface, in either instance, is necessary. Further, it may be necessary to form a first cut in a workpiece, at a first angle with respect to the edge of the workpiece, and a continuation of the first cut, i.e., a second cut, at a second angle with respect to a point of termination of the first cut. Also, a line mark may be necessary to assemble one workpiece with another workpiece in an angular relationship.

Such line markings will provide for the guidance of a tool in forming a cut at an angle with respect to a reference, or with respect to a point on the work surface, and also when assembling one workpiece angularly with another workpiece.

When forming angularly arranged line markings on the surface of a workpiece, a conventional protractor may be used to facilitate the location and angular alignment of such markings. A first type of protractor is formed with structure which facilitates the placement, and movement, of the protractor on a surface of a workpiece. With this type of protractor, the edge of the workpiece can not be used as a guide in the placement of the protractor.

A second type of protractor is formed with structure which facilitates the guidance of the protractor along the edge of the workpiece for placement of the protractor on the surface of the workpiece. The structure, however, prevents the use of the protractor in the manner of the first protractor described above.

Thus, there is a need for a versatile protractor which can be used for placing angular line markings on a surface of a work piece by freely moving the protractor over the surface, or by using an edge of the workpiece as a guide for the protractor.

Thus, there is a need for a versatile protractor which can be moved freely over the surface of the workpiece, or guided along the edge of the workpiece, in the placement of angular line markings on the workpiece surface.

Use of a protractor would be greatly enhanced if the protractor included structure which could support a laser marker therewith. Further, a protractor with a laser marker would facilitate accurate and prompt projection of a beam-generated line mark onto a workpiece surface.

Thus, there is a need for a versatile protractor with structure for supporting a laser marker, and for such a protractor with the laser marker.

Also, there is a need for a versatile laser marker which can be used as a stand-alone laser marker, used with a tool, such as a circular saw, and used with a protractor.

### SUMMARY OF THE INVENTION

It is, therefore, an object of this invention is the provision of a protective and sturdy housing of a laser marker for maintaining a factory-tuned mounting of a laser, within the laser marker.

An additional object of this invention is the provision of a versatile laser marker which can project accurately a line mark onto a surface of a workpiece with respect to a reference point on the surface or on an edge of the workpiece.

Another object of this invention is the provision of a laser marker which is formed with substantial supporting structure and is located on a tool in such a manner to provide a stabilized mounting, and which facilitates rapid and accurate assembly of the laser marker with, and rapid disassembly of the laser marker from, the tool.

Still another object of this invention is the provision of a versatile protractor which can be used for placing angular line markings on a surface of a workpiece with respect to a reference point on the surface by unencumbered placement of the protractor on the surface or by alignment of the protractor with an edge of the workpiece.

A further object of this invention is the provision of protractor with a laser marker which can project a line mark, in the form of a laser beam, onto a surface of a workpiece.

Still a further object of this invention is the provision of a versatile multi-use laser marker for use (1) as a stand-alone layout accessory for accurately projecting line marks onto a workpiece, (2) in combination with a tool for facilitating guidance of the tool during a work process, and (3) in combination with a protractor for accurately projecting angular line marks.

With these and other objects in mind, this invention contemplates a laser marker having a housing formed with a wall, and a window formed through the wall. A shelf is located within the housing adjacent the window, and a laser is located on the shelf and situated to direct a laser beam, generated thereby, through the window. Means, extending externally of the housing, are provided for locating the housing on a first surface of a workpiece with respect to a reference point on the first surface, or with respect to a second surface of the workpiece angularly displaced from and contiguous with the first surface, to facilitate projection of the laser beam upon the workpiece.

This invention also contemplates a laser marker with a housing formed with a wall, and a window formed through the wall. A shelf is located within the housing adjacent the window, and a laser is located on the shelf and situated to direct a laser beam, generated thereby, through the window. The housing is formed by an assembly of a pair of shell-like sections and a wall section. The pair of shell-like sections, when assembled, form at least a first of two portions of a rear of the housing. The wall section, when assembled with the pair of shell-like sections, forms a second of the two portions of the rear.

This invention further contemplates a tool with a laser marker, and having a tool housing. A plate is attached to the tool housing for engaging a surface of a workpiece to facilitate movement of the tool and the plate over the surface of the workpiece. A laser is removably supported on the plate for projecting a laser beam marker onto the surface of the workpiece.

This invention additionally contemplates a circular saw with a laser marker, and having a circular saw housing. A circular saw shoe is attached to the circular saw housing, and a laser is removably supported on the circular saw shoe in a position to project a laser beam generated thereby.

Also, this invention contemplates a protractor including a base having a perimeter, a first base surface on one side thereof and a second base surface on the opposite side thereof. A rim extends about at least a portion of the perimeter of the base, and between a first end of the rim and a second end of the rim spaced from the first end the rim The rim is formed with a first edge located by a prescribed riser distance outward from the first base surface. The rim is also formed with a second edge located by the prescribed riser distance outward from the second base surface. A first leg extends outward from the first end of the rim and outward from the second base surface. A second leg extends outward from the second end of the rim and outward from the second base surface. Indicia is located on the first base surface for establishing angular relationships when the second edge of the rim is placed in engagement with a first surface of a workpiece, and the first leg and the second leg are placed in engagement with a second surface of the workpiece, which is contiguous with the first surface Indicia is also located on the second base surface for establishing angular relationships when the first edge of the rim is placed in engagement with the first surface of the workpiece.

Further, this invention contemplates a protractor formed with structure for assembly with a laser marker, and includes a base formed with a base surface. A first circular guide track extends outward from the base surface to an outward edge thereof and is formed at a first track diameter. A second circular guide track extends outward from the base surface to an outboard edge thereof and is formed at a second track diameter which is less than the first track diameter. The first circular guide track and the second circular guide track are formed concentrically about a common axis. A support surface is formed between the outboard edge of the first circular guide track and the outboard edge of the second circular guide track at a location outward of the base surface in a support surface plane, with the support surface defining a circular path.

Still further, this invention contemplates a protractor with a laser marker, including a base having a base surface, and a support surface formed at a location outward, and about an axis, of the base surface in a support surface plane, with the support surface defining a circular path. A laser housing, with a laser located within the laser housing, is situated to direct a laser beam, generated by the laser, from the laser housing. The laser housing is positioned on the support surface for selective movement over the support surface and along the circular path.

Other objects, features and advantages of the present invention will become more fully apparent from the following detailed description of the preferred embodiment, the appended claims and the accompanying drawings.

### BRIEF DESCRIPTION OF THE DRAWINGS

In the accompanying drawings:

FIG. 1 is a perspective view showing a front and left side of a laser housing of a laser marker in accordance with certain principles of the invention;

FIG. 2 is a perspective view showing a rear, a right side and a top of the laser housing of FIG. 1 in accordance with certain principles of the invention;

FIG. 3 is a perspective view showing the rear, the right side and a base of the laser housing of FIG. 1 in accordance with certain principles of the invention;

FIG. 4 is a perspective view showing the laser housing of FIG. 1 with a shell-like section removed to reveal the interior of the laser housing in accordance with certain principles of the invention;

FIG. 5 is a partial sectional view taken along line 5-5 of FIG. 3 showing a magnet mounted in a nest in the base of the laser housing in accordance with certain principles of the invention;

FIG. 6 is a schematic representation showing the laser located within a barrel and directing a laser beam through a lens system and onto the surface of a workpiece in accordance with certain principles of the invention;

FIG. 7 is a top view showing a laser adjusting facility mountable within the laser housing of FIG. 1 in accordance with certain principles of the invention;

FIG. 8 is a rear perspective view, with parts broken away, showing the laser housing of FIG. 1 positioned on a surface of a workpiece with respect to a reference point on the surface in accordance with certain principles of the invention;

FIG. 9 is a rear view showing the laser housing of FIG. 1 positioned on the surface of the workpiece with respect to a reference point on an edge of the workpiece in accordance with certain principles of the invention;

FIG. 10 is a rear view showing the laser housing of FIG. 1 positioned on the surface of the workpiece with respect to a corner of the edge of the workpiece in accordance with certain principles of the invention;

FIG. 11 is a perspective view showing the circular saw of FIG. 11 with the laser housing of FIG. 1 positioned on the mounting platform of FIG. 11 in accordance with certain principles of the invention;

FIG. 12 is a partial perspective view showing a mounting platform on a shoe of a circular saw in accordance with certain principles of the invention;

FIG. 13 is a perspective view showing a first side of a protractor in accordance with certain principles of the invention;

FIG. 14 is a perspective view showing a second side of the protractor in accordance with certain principles of the invention;

FIG. 15 is a perspective view showing the first side of the protractor of FIG. 13 with the laser housing of FIG. 1 positioned on the first side of the protractor in accordance with certain principles of the invention;

FIG. 16 is a perspective view showing the laser housing of FIG. 1 in assembly with the first side of the protractor of FIG. 13 which is positioned on the surface of the workpiece of FIG. 6 with respect to the edge of the workpiece in accordance with certain principles of the invention; and

FIG. 17 is a perspective view showing the laser housing of FIG. 1 in assembly with the second side of the protractor of FIG. 14 which is positioned on the surface of the workpiece of FIG. 6 with respect to a reference point on the surface in accordance with certain principles of the invention.

### DETAILED DESCRIPTION OF THE PREFERRED EMBODIMENTS

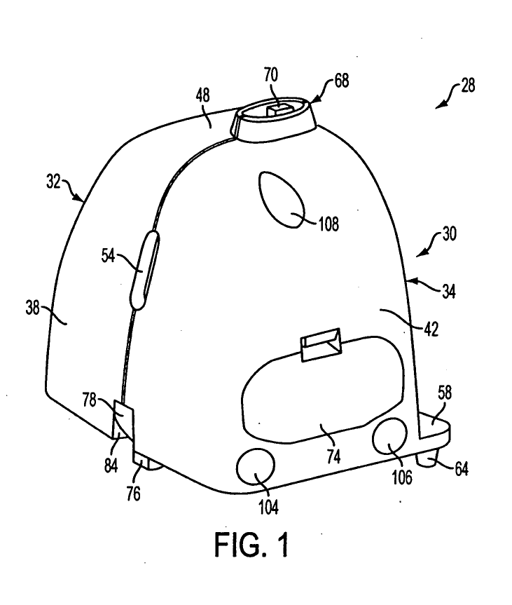

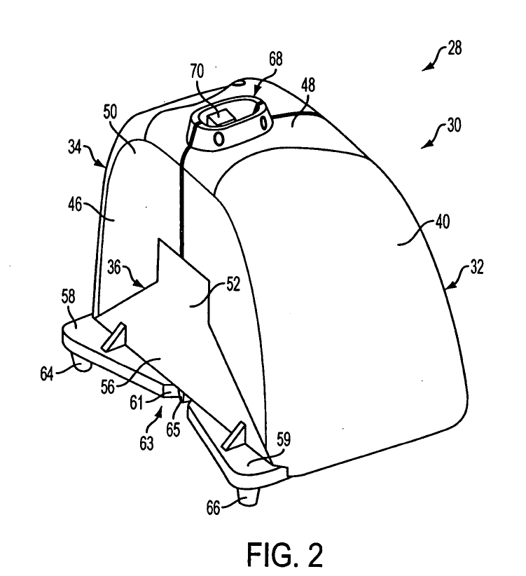

As shown in FIGS. 1, 2 and 3, a laser marker 28 includes a laser housing 30 which is formed by a plurality of sections, including two plastic shell-like sections 32 and 34, and a metal wall section 36. When the shell-like sections 32 and 34, and the wall section 36, are assembled, the laser housing 30 includes a wall or front 38, a right side 40, a left side 42 spaced from the right side, a base 44, a rear 46, and a top 48, which define an interior or enclosure 49 of the laser housing. The rear 46 of the laser housing 30 includes two portions, with a first portion 50 of the two portions being formed by the shell-like sections 32 and 34, and a second portion 52 of the two portions being formed by the wall section 36. A window 54 is formed generally centrally in the wall or front 38, and is elongated in a direction between the base 44 and the top 48.

The plastic shell-like sections 32 and 34 are formed from a hard impact resistant, preferably moldable, material such as a hard thermoplastic material. Examples of such hard thermoplastic materials are ABS, polystyrene, and the like. Other hard thermoplastic materials could be used without departing from the spirit and scope of the invention. The wall section 36 is formed from a metal material such as, for example, zinc, aluminum, and the like. Other metals could be used without departing from the spirit and scope of the invention. With this arrangement, the shell-like sections 32 and 34 are composed of a first material, and the wall section 36 is composed of a second material dissimilar from the first material.

The hard thermoplastic material of the shell-like sections 32 and 34, and the metal material of the wall section 36, combine to provide a protective and sturdy laser housing 30. In the preferred embodiment, the laser housing 30 is constructed from the three sections, i.e., the plastic shell-like sections 32 and 34, and the metal wall section 36. However, the laser housing 30 could be constructed from two, four or more sections, with the sections composed of plastic or metal, or various combinations of plastic and metal, without departing from the spirit and scope of the invention.

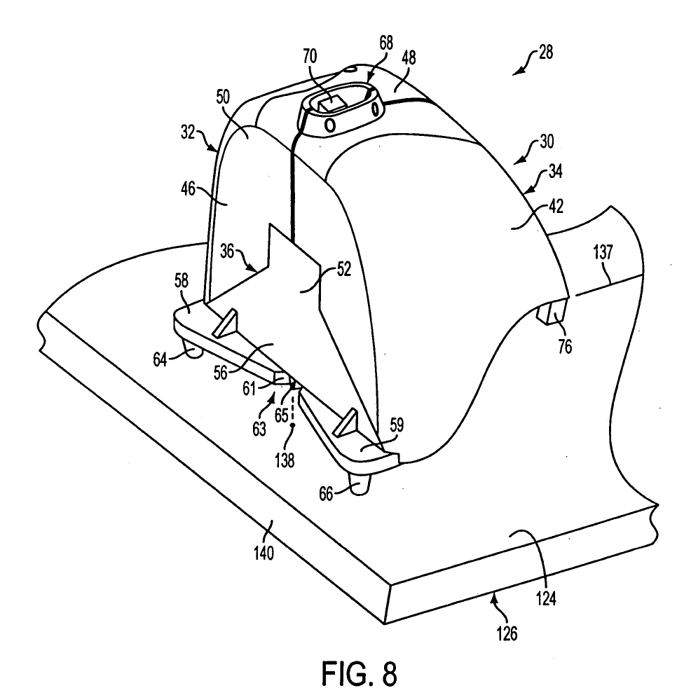

The wall section 36 is formed with a portion 56, which is located in a plane common to the rear 46 of the laser housing 30. The wall section 36 is further formed with two shelves 58 and 59, each of which extends perpendicularly from the portion 56 of the wall section 36, rearward and outward of the laser housing 30. Each of the shelves 58 and 59 is formed with tapered sections which taper inward from outboard ends thereof to a slot 61 between respective inboard ends thereof. A marking notch 63, with an alignment mark 65, is located within the slot 61 and is in alignment with the window 54, and a laser beam eventually projected through the window. This arrangement facilitates the locating of the laser housing 30 over a surface 124 (FIG. 8) of a workpiece 126, with respect to a reference point on the surface.

An undersurface 60 of the wall section 36 is flush with an external surface 62 of the base 44, with the undersurface and the external surface being located in an common external plane. The wall section 36 is formed fixedly with a first reference or support leg 64, and a second reference or support leg 66, spaced from the first leg, hereinafter referred to as the first leg and the second leg. Each of the spaced first and second legs 64 and 66, respectively, extend perpendicularly, and outward by a prescribed extension distance, from the undersurface 60 of the wall section 36 and from the external plane.

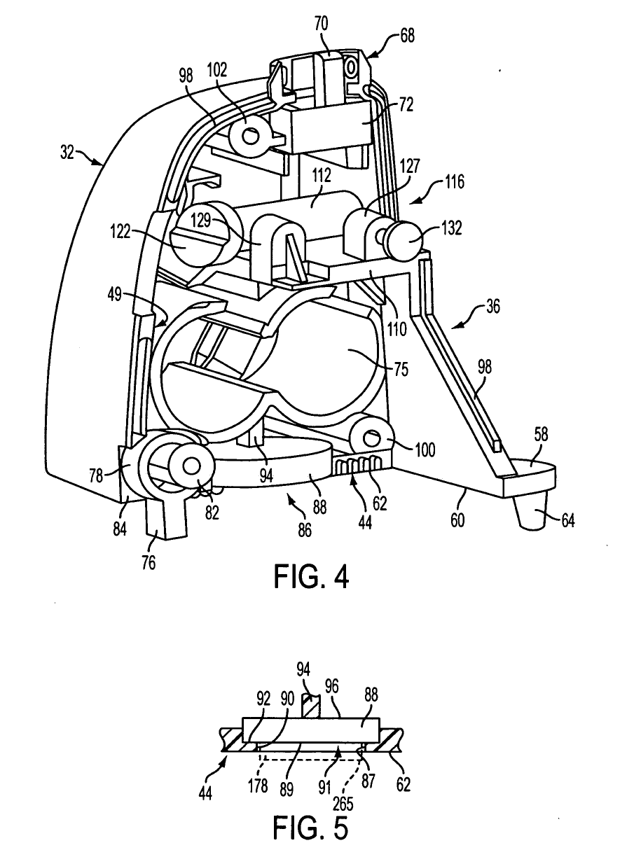

An open-top chamber 68 extends outward from the top 48 of the laser housing 30, and provides protection for a button 70 of a slide switch 72 (FIG. 4), which is mounted in the interior 49 of the laser housing. A battery door 74 is attachable to the laser housing 30 along the left side 42 thereof, and provides concealable access to a battery compartment 75 (FIG. 4) in the interior 49 of the laser housing.

As shown in FIGS. 1, 3 and 4, a third reference and support leg 76, hereinafter referred to as the third leg, is mounted for pivotal movement with respect to the laser housing 30, and is located centrally along a common edge of the laser housing where the front 38 and the base 44 are contiguous. The third leg 76 is formed integrally with a ring 78, which, as shown in FIG. 4, is mounted over a boss 82, located within the interior 49 of the laser housing 30. The ring 78 is mounted for rotational movement about the boss 82 to thereby provide for pivotal and retracting movement of the third leg 76. A slot 84 is formed in contiguous portions of the front 38 and the base 44 to provide for limited pivotal movement of the third leg 76 through an angle of approximately ninety degrees, between two extreme positions.

In a first of the two extreme positions, which is referred to as a support position, the third leg 76 extends perpendicularly outward from the external plane of the base 44, as shown in FIG. 4, for a distance equal to the above-noted prescribed extension distance. In this position, the third leg 76 is parallel with the first leg 64 and the second leg 66, where the first, second and third legs form a plurality of legs extending from the external plane of the base 44 which are of equal length.

In the preferred embodiment of the laser marker 28, the first, second and third legs 64, 66 and 76, respectively, combine to form a plurality of supports. The plurality of supports could include four or more supports without departing from the spirit and scope of the invention.

In a second of the two extreme positions, which is referred to as a non-support position, the third leg 76 extends perpendicularly from the front 38 of the laser housing 30. In this manner, the third leg 76 is retractable to a position where the third leg extends from a portion of the laser housing 30 other than from the external plane of the base 44. Thus, when the third leg 76 is in a retracted position, as described above, the first leg 64 and the second leg 66 are the only legs extending outward from the external plane of the base 44.

The ring 78 of the third leg 76 is mounted within the laser housing 30 such that the third leg can be moved to any selected position within the above-noted range, and maintained in that selected position by a frictional assembly of the ring within the interior 49 of the laser housing. The third leg 76 can be moved to a position where the third leg continues to extend from the external surface 62 of the base 44, but by a distance less than the above-noted prescribed extension distance. This arrangement provides for a height adjustment for the laser housing 30.

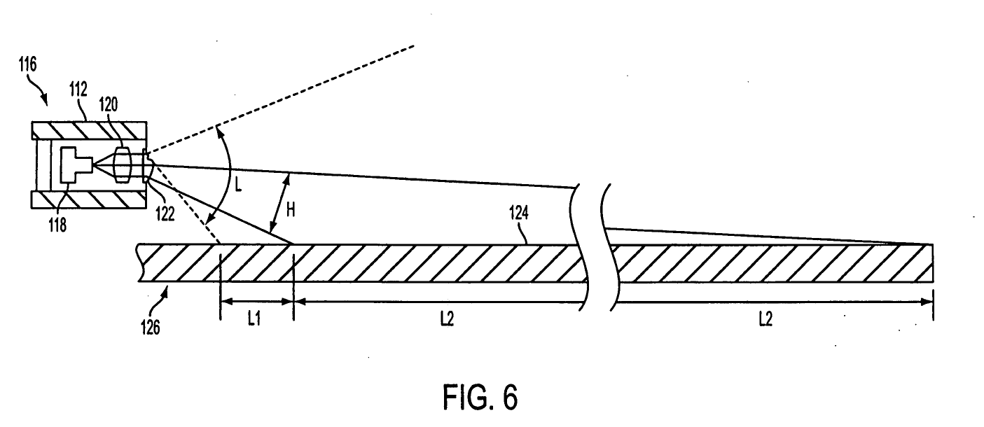

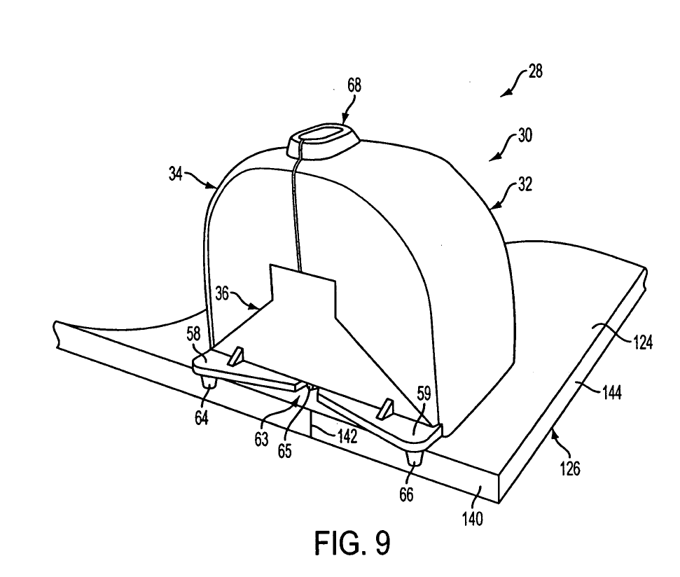

The first leg 64, the second leg 66, and the third leg 76 form a means extending externally of the laser housing 30 for locating the housing, and thereby a laser 118 (FIG. 6), on a first surface, such as the surface 124 (FIG. 8) of the workpiece 126, and with respect to the reference point on the first surface, or with respect to a second surface, such as an edge 140 (FIG. 9) of the workpiece, which is angularly displaced from and contiguous with the first surface, to facilitate projection of the laser beam upon the workpiece.

The means for locating the laser housing 30 on the first surface, i.e., the surface 124, of the workpiece 126, with respect to the second surface, i.e., the edge 140, of the workpiece, includes at least the first and second legs 64 and 66, respectively. Further, the means for locating the laser housing on the first surface, i.e., the surface 124, of the workpiece 126, with respect to a reference point on the first surface of the workpiece, includes at least the first leg 64, the second leg 66, and the third leg 76.

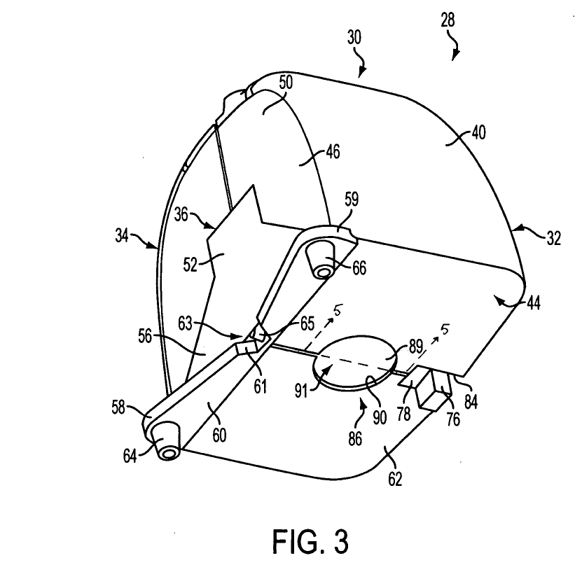

Referring to FIGS. 3, 4 and 5, a nest 86 is formed in a central location of the base 44 for receipt of a magnet 88 having a disc-like shape. The nest 86 includes a passage 90 of a prescribed diameter, which extends through the base 44 from a generally central portion of the external surface 62 and inward of the laser housing 30. A ledge 92 is formed about an inboard portion of the passage 90 at a diameter larger than the prescribed diameter of the passage. The magnet 88 is formed with a diameter which is approximately the same as the diameter of the ledge 92, whereby, when the magnet is placed on the ledge, the ledge forms a means located within the laser housing 30 for precluding movement of the magnet out of the nest 86 in a direction outward of the laser housing. In this mounting, a portion 89 of one side of the magnet 88 is exposed externally. Referring to FIG. 5, the externally exposed outboard portion 87 of the passage 90 and the externally exposed portion 89 of the magnet 88 form a recess 91, which extends inward from the external surface 62 of the base 44 by a prescribed recess distance.

A blocking member 94 is formed internally of the laser housing 30, and is positioned adjacent a top surface 96 of the magnet. The blocking member 94 serves as a means located within the laser housing 30 for precluding movement of the magnet 88 out of the nest 86 in a direction inward of the laser housing.

It is further noted that, when the shell-like section 34 is separated from the shell-like section 32, for example as shown in FIG. 4, a one-half portion of the nest 86 remains with the shell-like section 32. This arrangement facilitates a lateral positioning of the magnet 88 within the one-half portion of the nest 86. When the shell-like section 34 is assembled with the shell-like section 32, the full nest 86 is completed to capture the magnet 88 within the nest.

Referring further to FIG. 4, the visible edges of the shell-like section 32, and the wall section 36, which interface with mating edges of the shell-like section 34, are formed with ribs 98 which extend outward from the interfacing edges. The interfacing edges of the shell-like section 34 is formed with grooves (not shown) which are complementary to the ribs 98. The interfacing edges of the shell-like section 32 and the wall section 36, which are not visible in FIG. 4, are formed with complementary rib-and-groove structure, in the same manner. The rib-and-groove structure of the interfacing edges of the shell-like section 32 and 34, and the wall section 36, preclude lateral shifting amongst the shell-like sections and the wall section after the sections have been assembled to form the laser housing 30.

A pair of bosses 100 and 102 are formed internally of the shell-like section 32, in the same manner as boss 82. Inboard ends of the bosses 82, 100 and 102 interface with inboard ends of similar bosses 104, 106 and 108, respectively, shown externally in FIG. 1, which are formed internally of the shell-like section 34. This interfacing arrangement provides facility for the assembly of fastening screws (not shown) in the aligned bosses 82, 100 and 102, and 104, 106 and 108, respectively, to retain together the shell-like sections 32 and 34 and the wall section 36 in the formation of the laser housing 30.

It is noted that the metal wall section 36 provides, in effect, a strong back bone for the laser housing 30, while the hard thermoplastic shell-like sections 32 and 34, combine with the metal wall section, to form the protective and sturdy laser housing, in accordance with certain principles of the invention.

Referring further to FIG. 4, a metal shelf 110 is located within the laser housing 30, and is formed integrally with the metal wall section 36. The shelf 110 extends perpendicularly from the wall section 36, and into the interior 49 of the laser housing 30 to provide a rigid metal support for a laser barrel 112. A lens assembly 122 is located within the interior 49 of the laser housing 30, adjacent a beam-projecting end of the laser barrel 112. The shell-like sections 32 and 34 are formed internally with adjacent circular wells, which form the battery compartment 75 of the laser marker 28.

In the schematic representation of FIG. 6, a preferred embodiment of a laser assembly 116 includes a laser 118, such as a solid state laser diode, mounted within, and near a first end of two ends of, the laser barrel 112, which is located and supported on the metal shelf 110 (FIG. 4). The laser 118 is situated to project a laser beam through the window 54, and toward a second end of the two ends of the laser barrel 112, whereby the beam passes through a lens assembly, including a collimating lens 120 and a line lens 122. Thereafter, the beam is projected onto the surface 124 of the workpiece 126.

The line lens 122 is preferably a cylindrical lens, but could be prismatic, that is formed with at least two portions with significantly different focal distances to generate at least two superimposed laser planes with different divergence angles and trajectories. When the laser marker 28, and thereby the laser 118, is placed near the surface 124 of the workpiece 126, as shown in FIG. 6, two or more lines are projected onto the surface. At least a first line L1 of the two or more lines may be directed to strike the surface 124 at a short distance along the surface, while a second line L2 of the two or more lines may be directed to strike the surface at a longer distance. This preferably increases the overall length and/or the apparent brightness of the ultimate line on the surface 124 of the workpiece 126. Lines L1 and L2 may partially overlap or may be separated to further increase the length of the resulting line on the surface 124 of the workpiece 126.

The brightness of line L2 along the surface 124 of the workpiece 126 will depend on divergence angle H, i.e., the smaller the divergence angle, the brighter the line L2 at a given distance. A larger divergence angle L will create the line L1, with a low density, that will strike the surface 124 of the workpiece 126 closer to the laser assembly 116, thereby reducing the laser line gap left by line L2.

A laser assembly, having features as in the above-described laser assembly 116, is described in detail in U.S. Patent Application Publication No. 2003/0231303 A1, published on Dec. 18, 2003, the description and illustrations of which are incorporated into this application by reference thereto. In particular, as illustrated and described in the above-noted Patent Application Publication, the laser assembly 40′ of FIG. 4B of the Publication, in combination with the line lens 45′ of FIG. 4G of the Publication, have features such as those in the above-described laser assembly 116.

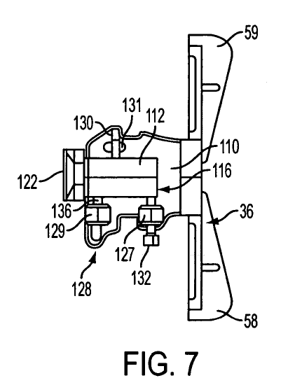

As illustrated in FIG. 7, and partially in FIG. 4, an adjusting facility 128 forms a means internal of the laser housing 30 for adjusting the position of the barrel 112, and thereby the laser 118, relative to the window 54. In particular, the metal shelf 110 extends into the interior 49 of the laser housing 30 and provides a rigid support for the laser assembly 116. A first post 127 and a second post 129 are formed with, and extend above, the shelf 110 adjacent opposite respective first and second ends of a first horizontal side of the laser barrel 112. A support rib 131 is formed with, and extends above, the shelf 110 adjacent an intermediate portion of a second horizontal side of the laser barrel 112.

A calibration screw 132 is threadedly mounted in the first post 127, with the threaded end thereof extending into engagement with the first end of the horizontal side of the laser barrel 112. A compression spring 136 is located between an inboard side of the second post and the second end of the horizontal side of the laser barrel 112. A pivot pin 130 is supported in the support rib 131, and extends into engagement with the adjacent intermediate portion of the second horizontal side of the laser barrel 112.

The adjusting facility 128 is used at the manufacturing location to adjust the position the laser barrel 112, and thereby the laser 118, so that the laser beam projects through the window 54 of the laser housing 30 and onto the work surface 124 in the manner required for efficient and proper operation of the laser marker 28. When the components of the laser marker 28 have been assembled as shown in FIG. 4, i.e., without the shell-like section 34, the laser 118 is operated and projection of the laser beam is observed.

In particular, the legs 64 and 66 of the housing 30 are placed against the edge 140 of the workpiece 126, and an observation is made to determine whether the beam, or laser line, ideally passes through the window 54 and is perpendicular with the edge 140. If the beam does not pass properly through the window 54, and/or the beam is not perpendicular with the edge 140, the calibration screw 132 is manipulated toward, or away from, the laser barrel 112 and, in conjunction with the biasing action of the spring 136, facilitates horizontal pivoting of the laser barrel about the pivot pin 130, and thereby ideal alignment of the laser beam. After the adjustment procedure has been completed, the remainder of the components of the laser housing 30 can be assembled to complete the assembly of the laser marker 28.

Referring to FIG. 8, when the laser marker 28 is to be used with respect to a reference point located on the surface 124 of the workpiece 126, the third leg 76 is pivoted to the position where the leg extends outward from the external surface 62 of the base 44, and where the leg is parallel to the first and second legs 64 and 66, respectively.

The first, second and third legs 64, 66 and 76, respectively, are placed on the surface 124 of the workpiece 126, whereby the laser housing 30 is located above the surface for unencumbered movement about the surface. The laser marker 28 can then be moved over and about the surface 124 to any desired location on the surface, thereby to project the laser beam onto a desired location of the surface to establish a beam-generated line mark 137. For example, the reference point is represented by a reference mark 138 (FIG. 8) on the surface 124 of the workpiece 126, the alignment mark 65, which is located in the marking notch 63 of the laser housing 30, is aligned with the reference point or mark 138. The laser housing 30 is thereafter manipulated about the reference mark 138, with the alignment mark 65 continuing to be aligned with the reference mark 138, to place the laser beam, in the form of the beam-generated line mark 137, on the surface 124 of the workpiece 126 in the desired direction and location.

Referring to FIG. 9, when the laser marker 28 is to be used with respect to a reference point or mark 142 located on the edge or surface 140 of the workpiece 126, the third leg 76 is pivoted or retracted from the extended support position illustrated in FIG. 8 to a position where the leg is fully retracted as described above. The external surface 62 of the base 44 of the laser housing 30 is placed directly onto the surface 124 of the workpiece 126, with the first and second legs 64 and 66, respectively, being positioned laterally in engagement with the edge 140 of the workpiece 126. The laser marker 28 can then be moved over and about the portion of the surface 124, which is contiguous with the edge 140, to align the alignment the mark 65 with a reference mark 142, which is representative of the reference point on the edge. This manipulation of the laser marker 28 places the beam-generated line mark 137 (FIG. 8) on the surface 124 of the workpiece 126 in the desired direction and location, with respect to the reference mark 142 on the edge 140 of the workpiece 126.

In another use of the laser marker 28, a desired distance is measured along the edge 140 of the workpiece 126 from the contiguous edge 144, and a mark representing the desired distance, such as the mark 142, is placed on the edge 140, which is a first edge. The legs 64 and 66 of the laser marker 28 are placed against the edge 140, and the alignment mark 65 of the laser marker is aligned with the mark 142. The beam, or laser line, of the laser marker 28 is then projected onto the work surface 124, which is perpendicular to the edge 140. The laser line extends to a portion of the work surface 124, which is contiguous with a second edge (not shown) on a side of the workpiece 126 opposite the first edge 140. A new mark is then placed on the second edge at the juncture of the laser line and the second edge. The distance from the edge 144 to the new mark on the second edge is equal to the distance from the edge 144 to the edge 142 on the first edge 140.

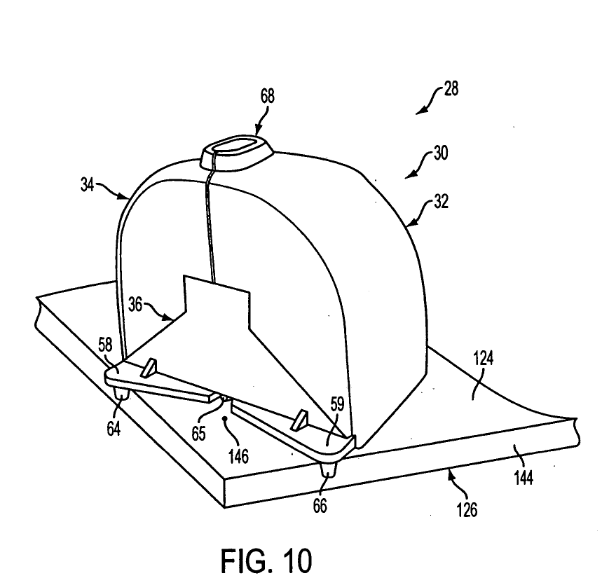

Referring to FIG. 10, the laser marker 28 can be used with respect to a corner of the workpiece 126, which is defined by contiguous portions of the edge 140, which is a first edge, and a second edge or surface 144 of the workpiece. With such use, the first leg 64 is in lateral engagement with the first edge 140 of the workpiece 126, and the second leg 66 is in lateral engagement with the second edge 144 of the workpiece. The laser marker 28 can be manipulated, while retaining the first and second legs 64 and 66, respectively, in lateral engagement with the edges 140 and 144, respectively. Eventually, the alignment mark 65 of the laser marker 28 is aligned with a reference point, such as, for example, a reference mark 146, located on the surface 124 of the workpiece 126. In this manner, the laser beam, and thereby the beam-generated line mark 137, can be placed on the surface 124 of the workpiece 126 in a desired direction and location.

Thus, the preferred embodiment of the laser marker 28 includes the plurality of support legs 64, 66 and 76, one of which is retractable, which facilitate movement of the laser marker to any location, and with respect to any reference point, on the surface 124 of the workpiece 126. Further, the preferred embodiment of the laser marker 28 includes the plurality of legs 66 and 64, which facilitate movement over portions of the surface 124 which are contiguous with the edge 140, and also the edge 144, of the workpiece 126, and with respect to any reference point on the surface 124 or the edges 140 and 144.

This structure demonstrates the versatility of the laser marker 28 for desired placement of the laser beam, and thereby the beam-generated line mark 137, on the surface 124 of the workpiece 126 with respect to any reference point on the surface or an edge of the workpiece. Also, the first leg 64, the second leg 66, and the third leg 76, which is retractable, provide a means for positioning the laser housing 30 to facilitate the projection of the laser beam, in any direction, onto the surface 124 of the workpiece 126, with respect to any reference point on the surface or on any edge of the workpiece.

It is noted that, while the preferred embodiment of the laser marker 28 includes the first, second and third legs 64, 66 and 76, respectively, with the third leg 76 being retractable, the laser marker could include four or more legs, without departing from the spirit and scope of the invention. Further, the laser marker 28 could include two or more retractable legs, without departing from the spirit and scope of the invention.

In numerous construction projects, tools of various types are used to perform work operations on a workpiece.

Frequently, the tool is to be guided over, or to be aligned on, the workpiece to facilitate performance of the desired work operation by the tool. In such instances, it would be beneficial if the guiding and aligning of the tool could be accomplished during the performance of the work operation.

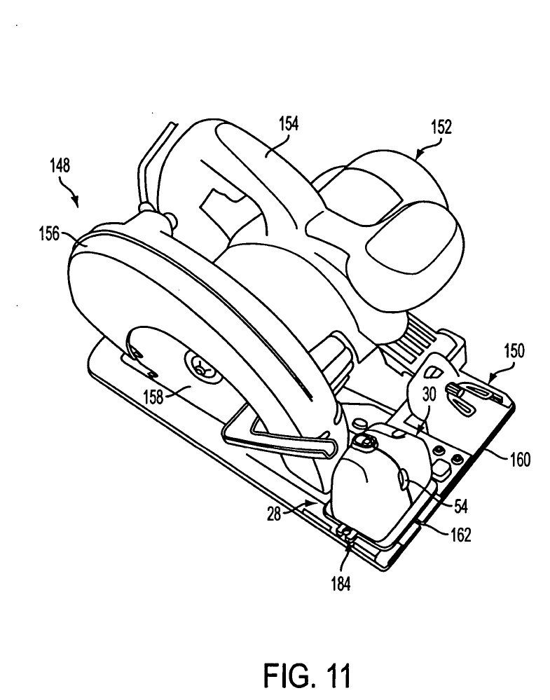

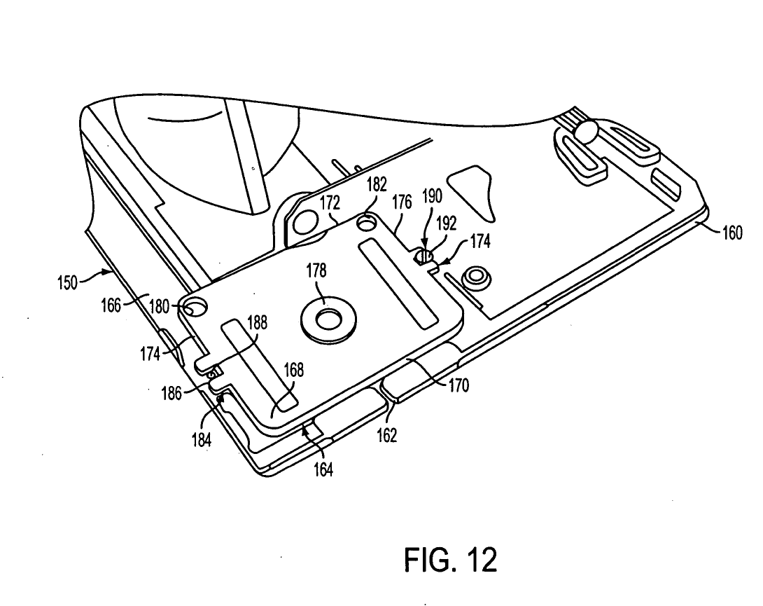

Referring now to FIG. 11, a tool, such as, for example, a circular saw 148, includes a plate or shoe 150, which is attached to a motor-and-drive mechanism housing 152 having a handle 154. A protective shield 156 is mounted for movement with respect to the housing 152, and shields a circular saw blade 158, which is mounted on the circular saw 148. A front portion of the shoe 150 of the circular saw 148, which is shown as a partial enlarged view in FIG. 12, is formed with a front edge 160 having a guide notch 162 formed therein, in alignment with the circular saw blade 158. In use of the circular saw 148, a user will align the guide notch 162 with a previously-placed scribed line mark on a workpiece, and will then move the circular saw guidingly over the scribed line mark to complete a cut in the workpiece.

In lieu of the scribed line mark on the workpiece 126, the laser marker 28 (FIGS. 1, 2 and 3), which contains the laser 118, can be assembled with, and removably supported on, the circular saw 148 in the manner described below. With this arrangement the beam-generated line mark 137 is provided, in the form of the projected laser beam, on the surface 124 of the workpiece 126, in accordance with certain principles of the invention.

An adjustable support platform 164 is mounted movably on an upper face 166 of the shoe 150, between the shield 156 and the front edge 160 of the support platform. The adjustable support platform 164 includes a top surface 168, a front edge 170, a rear edge 172, a right side edge 174 and a left side edge 176. The front edge 170 of the support platform 164 is spaced slightly inward of, and parallel with, the front edge 160 of the shoe 150.

A magnetically attractable ring 178 is mounted centrally in the support platform 164. The magnetically attractable ring 178 extends outward from the top surface 168 of the support platform 164 by a short distance, generally equal to the above-noted prescribed recess distance in the external surface 62 (FIG. 5) of the base 44 of the laser housing 30. A pair of spaced reference holes 180 and 182 are formed through the support platform 164, adjacent opposite corners of the rear edge 172.

A pair of lugs 184 (one shown) extend outward from central portions of each respective one of the right side edge 174 and the left side edge 176 of the support platform 164. Each of the pair of lugs 184 is formed with an elongated slot 186 (one shown), having an outward entry opening, where each of the slots is located over a respective one of a pair of threaded holes 188 (one shown) formed in the upper surface 166 of the shoe 150. A threaded portion of each of a pair of threaded members 190 (one shown) is inserted through a respective one of the slots 186 and into a respective one of the pair of threaded holes 188.

It is noted that the width of each of the elongated slots 186 is slightly larger than the diameter of the threaded portions of the threaded members 190. This arrangement allows limited rotational movement of the platform, in a horizontal plane and about the axis of the magnetically attractable ring 178, for adjustment of the laser marker 28 with respect to the alignment of the laser marker with the saw blade 158. Also, when the support platform is generally centrally located on the shoe 150, the threaded portions of each of the threaded members 190 are spaced outward from an inboard end of the respective slot 186. This arrangement allows limited side-to-side movement of the platform relative to the shoe 150, also for adjustment of the laser marker 28 with respect to the alignment of the laser marker with the saw blade 158.

Each of the threaded members 190 is formed with a head 192 (one shown) which is sufficiently large to preclude movement of the head through the respective one of the slots 186.

The pair of lugs 184 formed on the support platform 164, the slots 186 formed in the lugs, the threaded holes 188 formed in the circular saw shoe 150, and the threaded members 190 form a means for releasably securing the support platform to the circular saw shoe.

Referring again to FIG. 11, the laser marker 28 is assembled with the circular saw 148 by insuring that the third leg 76 is in the retracted position so that only the first and second legs 64 and 66, respectively, extend outward from the external plane of the laser housing 30. The laser housing 30 is then manipulated to position the first leg 64 and the second leg 66 into the reference holes 180 and 182, respectively, to properly locate the laser housing on the support platform 164. Thus, the first leg 64 and the second leg 66, in conjunction with the reference holes 180 and 182, respectively, provide a means for locating the laser housing 30, and thereby the laser 118, with respect to the support platform 164 to facilitate projection of the laser beam onto the workpiece 126.

As the external surface 62 of the base 44 of the laser housing 30 is moved toward the top surface 168 of the support platform 164, the externally exposed portions of the magnetically attractable ring 178 of the support platform enter the recess 91 in the external surface 62 of the base 44 of the laser housing 30. Eventually, the magnetically attractable ring 178 in the support platform 164 is magnetically attracted by the magnet 88 within the nest 86 of the laser housing 30, and the laser marker 28 is thereby magnetically retained with the support platform and the shoe 150 of the circular saw 148. Thus, the magnet 88 and the magnetically attractable ring 178 form a means for magnetically retaining the laser 118 with the circular saw shoe 150, and also form a means for releasably securing the support platform 164 to the circular saw shoe 150.

Thereafter, the laser marker 28 is operated to project the laser beam through the window 54 and generally onto the area of the shoe 150 to determine whether the laser beam is aligned with the saw blade 158. If the laser beam is not aligned with the saw blade 158, the heads 192 of the threaded members 190, which are visible and located outboard of the right side 40 and the left side 42 of the laser housing 30, are engaged and manipulated to relax the threaded mounting of the threaded members within the respective threaded holes 188, but not sufficiently to completely remove the threaded members. The adjustable support platform 164 is then moved from side to side, and if necessary, the platform is also rotated slightly, to reposition the laser marker 28 on the shoe 150, and thereby align the laser beam with the saw blade 158. Thereafter, the threaded members 190 are fastened tightly within the threaded holes 188, to thereby clamp the support platform 164 to the shoe 150 of the circular saw 148. It is noted that the elongation and width of the slots 186 of the support platform 164 allow the adjusting movement of the support platform to be accomplished, while loosely retaining the support platform with the shoe 150.

The circular saw 148 with the laser marker 28 can now be used during the work operation to cut the workpiece accurately along the beam-generated line mark 137 projected onto the workpiece by the laser 118 from within the laser housing 30.

When using a circular saw to perform a cutting operation, there is a tendency for a motor-and-drive mechanism housing and a protective shield to vibrate due to the reaction of the rotating saw blade with a workpiece. Such vibrations are minimal with respect to the cutting operation, and do not cause any deficiencies in the cutting of the workpiece. However, if a laser marker is mounted on the housing, and particularly on the shield, for the purpose of placing a guiding laser beam on the workpiece, the vibrations could cause a loss in the integrity of position and operation of the laser, and thereby affect the placement and intensity of the laser beam on the workpiece.

In the preferred embodiment of the circular saw 148 with the laser marker 28, the laser marker is mounted on the shoe 150 in front of the circular saw blade 158 and the protective shield 156. During operation of the circular saw 148 with the laser marker 28, the shoe 150 typically is resting, and is firmly supported, on a surface of a workpiece with the vibrations being limited to the other elements of the circular saw. In this manner, the circular saw 148 with the laser marker 28, as described above, is unaffected by such vibrations.

This advantage is further enhanced by the rigid metal wall section 36, the formation of the first and second reference legs 64 and 66 as an integral part of the metal wall section, and the formation of the laser-supporting metal shelf 110 as an integral part of the wall section.

Further, another advantage is obtained when the outward extension of the magnetically attractable ring 178 seats within the recess 91 of the laser housing 30, whereby lateral movement of the laser marker 28, with respect to the support platform 164 and the shoe 150 of the circular saw 148, is precluded. Such lateral movement is further precluded by placement of the legs 64 and 66 within the reference holes 180 and 182, respectively.

The adjustability of the support platform 164 with respect to the shoe 150 also enhances the circular saw 148 with the laser marker 28 by insuring that the projected laser beam is appropriately aligned with the saw blade 158. In addition, the above-described advantages and features of the laser marker 28 are also embodied in the circular saw 148 with the laser marker.

In many work projects, a guiding or aligning line mark is to be placed on a workpiece, in an angular relation to a reference point, which may be located on a reference line scribed on the workpiece. Angular line marks of this type are typically scribed on the workpiece by use of a protractor. The reference point and reference line are located on a first surface of the workpiece on which the angular line mark is to be scribed.

To facilitate the angular location of the line mark with respect to the reference point on the reference line, a first type of protractor is placed on the first surface to align indicia on the protractor with the reference line, and to locate a center point of the protractor over the reference point. Other indicia on the protractor is then used to determine the angular location of a line point, which will be located on the subsequently scribed angular line mark. The line point is marked and the protractor is removed from the first surface, whereafter the angular line mark is scribed between, and beyond if desired, the reference point and the line point.

When the reference point on the first surface is near a second surface, or edge, of the workpiece, which is contiguous with the first surface, a second type of protractor, having aligning structure alignable with the edge of the workpiece, can be used to align the center point over the reference point on the first surface. Thereafter, the angular location of the line point is determined, and marked, by use of the protractor as described above. The protractor is removed and the line mark is scribed between, and beyond if desired, the reference point and the line point.

The structure of the first type of protractor facilitates a flush interface between the first surface of the workpiece and the protractor, to provide an accurate determination of the angular location of the line mark with respect to the reference point. The aligning structure of the second type of protractor would interfere with, and prevent, the flush interface between the first surface and the protractor. Similarly, the lack of the aligning structure on the first type of protractor would preclude accurate determination of the location of the line point when using the edge of the workpiece as an alignment surface. Consequently, two separate types of protractors would be required under the circumstances described above.

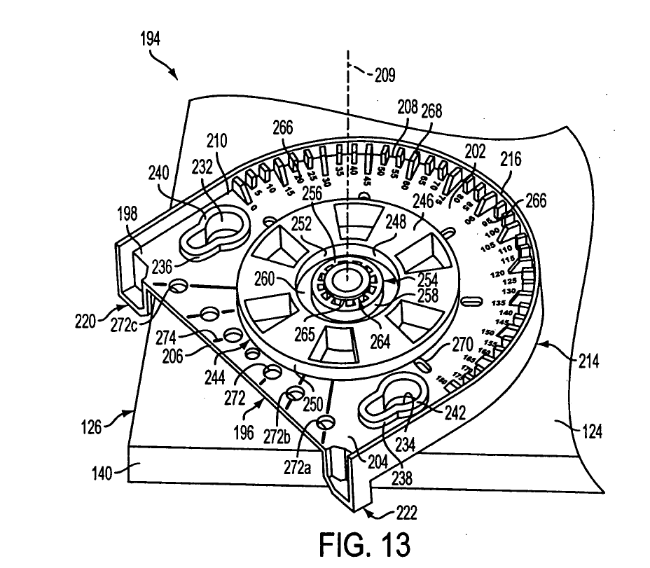

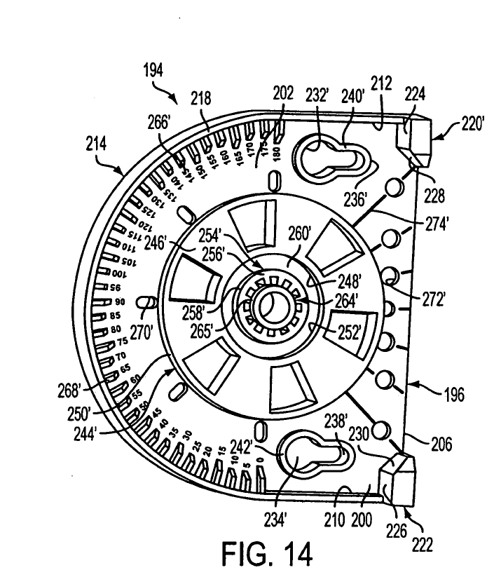

As illustrated in FIGS. 13 and 14, a versatile protractor 194 can be used to determine the angular location of a line mark on a first surface, such as the surface 124 of the workpiece 126, with respect to a reference point on a reference line on the first surface, or with respect to a reference point on the first surface, in conjunction with a second surface or edge of the workpiece, which is angularly displaced from, and contiguous with, the first surface.

The protractor 194 is formed with a base 196 having a first major or base surface 198 on one side of the base, a second major or base surface 200 on an opposite side of the base, and a perimeter which surrounds the base. The base 196 is formed with a semicircular section 202 in a forward portion thereof, and a rectangular section 204, formed integrally with the semicircular section, which extends from its juncture with the semicircular section to a rear edge 206 of the base. The semicircular section 202 is formed with an outer perimeter edge 208, which tracks a semicircular configuration about an axis 209 of the protractor 194. The rectangular section 204 is formed with opposite side edges 210 and 212 which extend, from opposite ends of the outer perimeter edge 208, to the rear edge 206 of the base 196.

The protractor 194 is also formed with a rim 214 which extends between first and second spaced ends thereof, and about at least a portion of the perimeter of the base 196, including the outer perimeter edge 208 of the semicircular section 202, and the opposite side edges 210 and 212 of the rectangular section 204. The rim 214 is formed with a first edge or rest surface 216, which is spaced outward from the first major surface 198 by a prescribed riser distance, and is located in a first riser plane. The rim 214 is formed with a second edge or rest surface 218, which is spaced outward from the second major surface 200 by the prescribed riser distance, and is located in a second riser plane.

A pair of alignment legs, such as a first leg 220 and a second leg 222, are formed integrally with, and extend outward from, the second major surface 200, slightly inboard of opposite ends of the rear edge 206 of the base 196. In addition, the first leg 220 extends outward from the first end of the rim 214, and the second leg 222 extends outward from the second end of the rim. The pair of alignment legs 220 and 222 are formed with a first pair of alignment surfaces 224 and 226, respectively, which are located in a common plane slightly inboard of the rear edge 206 of the base 196. The pair of alignment legs 220 and 222 are also formed with a second pair of alignment surfaces 228 and 230, respectively, which are contiguous with the first pair of alignment surfaces 224 and 226, respectively. Each alignment surface of the second pair of alignment surfaces 228 and 230 is bevelled at an angle of forty-five degrees relative to the respective one of the first pair of alignment surfaces 224 and 226, and toward a juncture thereof with the rear edge 206 of the base 196.

The elements of the protractor 194, which are located on and extend outward from the first major surface 198 of the base 196, are essentially identical to the elements of the protractor, which are located on and extend outward from the second major surface 200 of the base. In the following description, only the details of the elements which are located on the first major surface 198 will be described, it being understood that the details of the elements located on the second major surface 200 are identical thereto. Further, prime versions of the numbers in FIG. 13, which identify the elements located on the first major surface 198, will be used to identify the corresponding elements located on the second major surface 200, as shown in FIG. 14. For example, a support platform 244 is located on the first major surface 198, and an identical support platform 244′ is located on the second major surface 200.

A pair of keyhole openings 232 and 234 are formed through spaced portions of the rectangular section 204 of the base 196. A pair of walls 236 and 238 extend around the pair of keyhole openings 232 and 234, respectively, and outward from the first major surface 198 by the prescribed riser distance. The pair of walls 236 and 238 are formed with outboard edges 240 and 242, respectively, which are located in the first riser plane.

The support platform 244 is formed in a circular configuration about the axis 209, with an outer riser surface 250 extending outward from the first base surface 198 to an outboard edge of the outer riser surface, by a prescribed riser distance. The outer riser surface 250 is formed at a prescribed platform outer diameter about the axis 209.

The support platform 244 is also formed with an inner riser surface 252 extending outward from the first base surface 198 to an outboard edge of the inner riser surface, by the prescribed riser distance. The inner riser surface 252 is formed at a prescribed platform inner diameter about the axis 209, which is less than the prescribed platform outer diameter. The support platform 244 is formed with a circular support surface 246, which extends between the outboard edges of the outer riser surface 250 and the inner riser surface 252, to form a circular path over the circular support surface.

The support surface 246 is located in a support surface plane, and is formed with a width defined by the radial distance between the prescribed platform outer diameter and the prescribed platform inner diameter. The support platform 244 extends outward from the first base surface 198 to the form surface, or support surface 246, by a prescribed platform distance, which is less than the prescribed riser distance of the rim 214.

A semispherical forward section of the support platform 244 is concentric with the semicircular section 202 of the base 196. A central opening 248 is formed radially inward of the inner riser surface 252, about the axis 209.

A circular hub 254 extends outward from the first major surface 198 about the protractor axis 209 and within the central opening 248, by the prescribed platform distance, and is concentric with the support platform 244. The circular hub 254 is formed with an outward surface 256, which is located in the support surface plane of the platform surface 246. Further, the circular hub 254 is formed with a prescribed hub outer diameter which is less than the prescribed platform inner diameter of the support platform 244, and is formed with an outer riser edge 258 which is spaced radially inward of the inner riser edge 248 of the support platform. In this manner, a circular space 260 is defined between the inner riser surface 252 of the support platform 244 and the riser edge 256 of the hub 254.

The circular hub 254 is formed with a central opening 262, which is sized to frictionally support a magnetically attractable element, such as a tube 264. The tube 264 includes an extended portion 265 extending axially outward from the hub outer surface 256 by a distance generally equal to, or slightly less than, the prescribed recess distance of the recess 91 (FIG. 5) of the laser housing 30.

A series of numerals 266, from “zero” to “one-hundred and eighty,” spaced by increments of five, are formed on the base surface 198, and the base surface 200, in a semicircle, or an angular array, to facilitate the positioning of the laser housing 30, and thereby the laser 118, at selected angular positions. The first numeral 266, which is “zero, is located adjacent the keyhole opening 232, while the last numeral in the series, which is “one-hundred and eighty,” is located adjacent the keyhole opening 234. Each of the numerals 266 represent an angular relationship with respect to an imaginary coordinate line extending radially from the protractor axis 209 to the number 266 which represents “zero.” A series of spaced ribs 268 extend outward from the first major surface 198 of the protractor 194, and radially inward from the inboard surface of the rim 214 to a location adjacent a respective one of the numerals 266.

Five spaced oblong openings 270 are formed in the first major surface 198 in a radial array between the outer riser surface 250 of the support platform 244 and respective ones of the numerals 266, and are spaced apart by angular increments of forty-five degrees. For example, a first of the five oblong openings 270 is located adjacent the numeral 266, which represents “zero.” A second of the five oblong openings 270 is located adjacent the numeral 266, which represents “forty five,” and the fifth oblong opening is located adjacent the numeral 266, which represents. “one-hundred and eighty.”

Seven spaced circular openings 272 are formed in a linear row adjacent, and parallel with, the rear edge 206 of the protractor 194. Seven guide marks 274 are formed on the first major surface 198 of the protractor 194, and extend from the rear edge 206 of the protractor, diametrically across respective ones of the seven circular openings 272, and continue to the outer riser surface 250 of the support platform 244. Each of the seven line marks 274 is aligned with a respective one of the numerals 266, which are spaced angularly apart in increments of fifteen degrees. For example, as shown in FIG. 13, the circular opening 272a, which is closest to the keyhole opening 234, is aligned with the numeral 266, which represents “forty-five degrees.” The circular opening 272b, which is adjacent to the circular opening 272a, is aligned with the numeral 266, which represents “sixty degrees,” and the circular opening 272c, which is adjacent the keyhole opening 232, is aligned with the numeral 266, which represents “one-hundred and thirty-five degrees.”

The numerals 266, the holes 270, the holes 272, and the guide marks 274, individually or collectively, form indicia located on the first major surface 198 for establishing angular relationships when the second edge 218 of the rim 214 is placed in engagement with a first surface, such as the surface 124 of the workpiece 126, and the first leg 220 and the second leg 222 are placed against spaced portions of a second surface, such as the edge 140 of the workpiece, which is contiguous with, and displaced angularly from, the first surface of the workpiece. The numerals 266′, the holes 270′, the holes 272′, and the guide marks 274′ form indicia located on the second major surface 200 for establishing angular relationships when the first edge 216 of the rim 214 is placed in engagement with the first surface 124 of the workpiece 126.

Occasionally, in a construction project, a line mark is to be scribed angularly on the first surface 124 (FIG. 8) of the workpiece 126, with respect to a reference point on a reference line previously scribed on the first surface. When using the protractor 194 to define the location of line mark, the first edge 216 of the rim 214 is placed on the surface 124 of the workpiece 126. The protractor 194 is then manipulated to align the axis 209, and the numeral 266, which represents “zero,” with the reference line on the surface. Thereafter, the axis 209 is located over the reference point on the reference line, and a reference mark is placed on the surface 124 in alignment with a selected one of the numerals 266, which represents the desired angular location of the line mark with respect to the reference line. The protractor 194 is then removed from the surface 124 and the line mark is scribed between, and may be extended beyond, the reference point on the reference line and the reference mark, which was placed on the surface with the aid of the protractor.

The reverse side of the protractor 194 can be used in a different mode when the reference line, and the reference point thereon, are located a prescribed edge distance from the edge of the workpiece. For example, the protractor 194 can be used in the different mode when the prescribed edge distance is equal to the distance between the above-noted imaginary coordinate line and the common plane of the alignment surfaces 224 and 226 of the pair of alignment legs 220 and 222. In such use, the alignment surfaces 224 and 226 are placed against the edge 140 of the workpiece 126, and the reference point on the surface 124 of the workpiece is aligned with the axis 209 of the protractor 194. The reference mark is then placed at the angular location, and the protractor 194 is then removed from the workpiece 126, whereafter the angular line mark is scribed as described above.

If the protractor 194 is to be used on a sloped or vertical surface, i.e., other than being horizontal, a pair of pins (not shown) with enlarged heads are precisely located and assembled on the surface on which the line mark is to be scribed. The larger portion of the keyholes 232 and 234 are positioned over the heads of the pair of pins, and the protractor 194 is shifted to move the smaller portions of the keyholes about shank portions of the pins. In this position, the protractor 194 is thereby retained with the surface 124 of the workpiece. The reference mark is then placed on the surface, and the angular line mark can be scribed on the surface in accordance with the procedure described above. Thus, the keyhole openings 232 and 234 provide a means for facilitating support of the protractor 194 on a surface of a workpiece at an angle other than horizontal.

In the foregoing manner, different modes of placement of a reference mark on the surface 124 of the workpiece 126, can be accomplished by using the single two-sided versatile protractor 194.

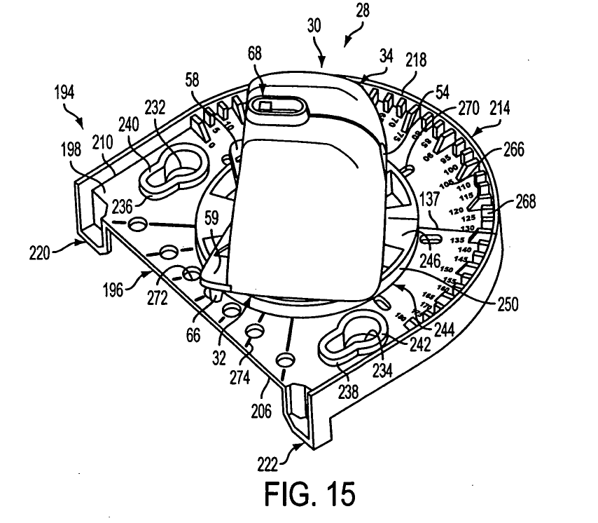

The use of the protractor 194 can be enhanced by using the laser marker 28 therewith. Referring to FIG. 15, the laser housing 30 can be placed on either support platform 244 or 244′, and can be positioned to align the laser beam with any desired numeral 266 or 266′, respectively, to project the beam-generated line mark 137 onto the surface 124 of the workpiece 126.

Referring to FIG. 13, the outer riser surface 250 of the support platform 244 forms a first circular guide track, which extends outward from the first major or base surface 198 to an outboard edge thereof, which is, in effect, the outboard edge of the outer riser surface. Further, the first circular guide track is formed at a first track diameter with respect to the axis 209, which is, in effect, the prescribed platform outer diameter. The inner riser surface 252 of the support platform 244 forms a second circular guide track, which extends outward from the first major or base surface 198 to an outboard edge thereof, which, in effect, is the outboard edge of the inner riser surface. Further, the second circular guide track is formed at a second track diameter with respect to the axis 209, which, in effect, is the prescribed platform inner diameter and is less than the first track diameter.

The first circular guide track and the second circular guide track are formed concentrically about a common axis, i.e., the axis 209. The platform or support surface 246 is formed between the outboard edge of the first circular guide track and the outboard edge of the second circular guide track at a location outward of the first major or base surface 198 in the support surface plane. The platform or support surface 246 thereby defines the circular path.

When the laser housing 30 is assembled with the protractor 194, the base 44 of the laser housing is placed on the support platform 244, where the external surface 62 of the base interfaces with the platform surface 246. At the same time, the first leg 64 and the second leg 66 of the laser housing are placed in engagement with the outer riser surface 250, i.e., in engagement with the first circular guide track. Further, the third leg 76 is placed in engagement with the inner riser surface 252, i.e., in engagement with the second circular guide track. In addition, when the laser housing 30 is placed on the support surface 246 of the support platform 244, the extended portion 265 of the tube 264 enters the recess 91 (FIG. 5), whereby the tube is placed in engagement with or closely adjacent, and magnetized by, the magnet 88. In this manner, the magnet 88 and the magnetically attractable tube 264 magnetically retain the laser housing with the protractor 194. Further, while the laser housing 30 is magnetically retained on the support surface 246, the laser housing can be rotated about the axis 209 to selectively position the laser beam onto the workpiece 126.

In this manner, the magnet 88 and the magnetically attractable tube 264 provide a means for retaining the laser housing 30 with the protractor 194 while allowing movement of the laser housing over the circular path of the support platform 244.

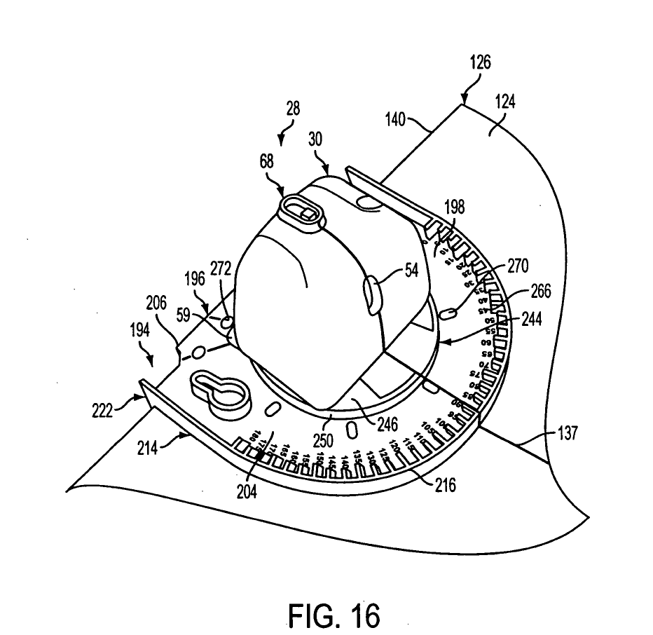

As illustrated in FIGS. 15 and 16, the protractor 194 with the laser marker 28 is shown in a first mode where the alignment legs 220 and 222 are placed against the edge 140 (FIG. 9) of the workpiece 126. The laser housing 30 can be rotated about the axis 209 of the protractor 194, whereby the first leg 64 and the second leg 66 are moved guidingly about the first circular track. At the same time, the third leg 76 is moved guidingly about the second circular track. With this mounting, the positioning of either of the first leg 64 or the second leg 66, or both legs together, adjacent or in engagement with the outer riser surface 250, preclude the laser housing 30 from moving radially or laterally inward on the support surface 246 of the support platform 244. In addition, the positioning of the third leg 76 adjacent or in engagement with the inner riser surface 252 precludes the laser housing 30 from moving radially or laterally outward on the support surface 246 of the support platform 244.

Thus, at least one of the two legs 64 and 66, and the third leg 76, in conjunction with the outer riser surface 250 and the inner riser surface 252, provide means for precluding radial movement of the laser housing with respect to the axis 209.

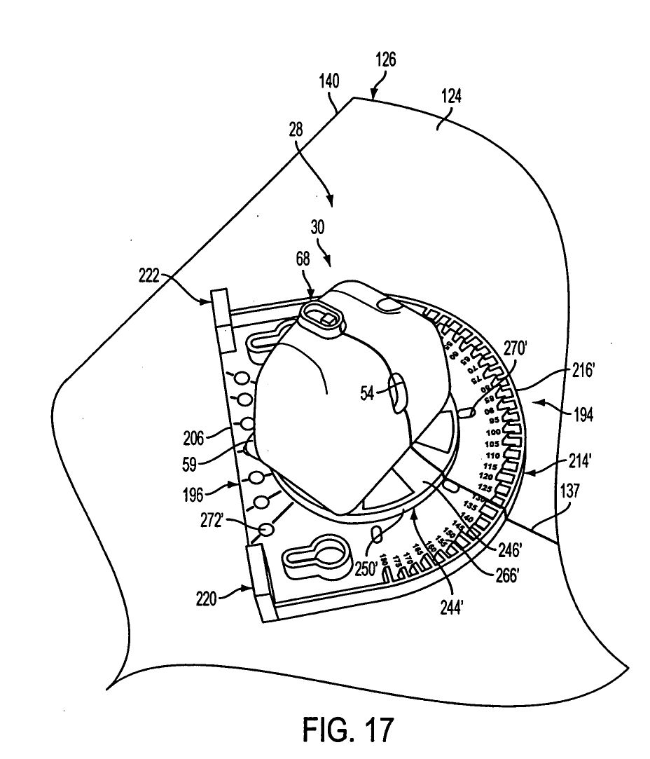

The protractor 194 with the laser marker 28 can be used in a second mode as shown in FIG. 17. In the second mode, the protractor 194 is turned over and the edge 216 of the rim 214 is placed on the surface 124 of the workpiece, whereby the alignment legs 220 and 222 of the protractor extend in a direction outward from the surface, and are not functional in this mode. The laser marker 28 is then placed on the support platform 244′ and functions in the same manner as described above. The support surface 246′ of the support platform 244′ and the outer and inner riser surfaces 250′ and 252′, respectively, form a third circular guide track and a fourth circular guide track which function in the same manner as described above with respect to the first and second circular guide tracks.

It is noted that each of the edges 216 and 218 of the rim 214 form a rest surface of the base 196, which is positionable on the surface 124 of the workpiece 126 to support the base and the laser housing 30 during use of the protractor with the laser marker 28. Further, the alignment leg 220 and the alignment leg 222, which are spaced from each other, extend from spaced portions of the rest surface in a direction away from the base and the rest surface.

Thus, in the manner described above, the versatile laser marker 28 can be used alone, with a tool, such as, for example, the circular saw 148, or with the protractor 194. In addition, the protractor 194 is formed with structure which facilitates the use of the single protractor in two modes, i.e., with or without the laser marker 28.

In general, the above-identified embodiments are not to be construed as limiting the breadth of the present invention. Modifications, and other alternative constructions, will be apparent which are within the spirit and scope of the invention as defined in the appended claims.

1. A tool for aligning and cutting a workpiece, comprising:
a tool having a cutting member for cutting a workpiece; and
a stand-alone laser marker that can be used alone or in conjunction with the tool, the laser marker being capable of being quickly attached and detached from the tool and projecting a visible line onto the workpiece while the tool performs its cutting action.

2. The tool recited in claim 1, wherein:
the tool includes a support platform thereon for releasably securing said laser marker, the support platform being adjustable relative to the cutting member to align the laser marker to the cutting member.

3. The tool recited in claim 2, wherein:
the support platform includes lugs extending from opposite sides thereof, the lugs on each side forming a slot through which a fastening member is inserted and secured to the tool, the fastening member being tightened to fixedly secure the support platform to the tool and loosened to release the support platform for adjustment relative to the tool.

4. The tool recited in claim 2, wherein:
the tool is a circular saw having a shoe, and the support platform is located on a front portion of the shoe adjacent the cutting member.

5. The tool recited in claim 1, wherein:
the tool includes a support platform with one of a magnet or a magnetizable metal, the laser marker including the other of a magnet or magnetizable metal, and the laser marker being capable of being quickly attached and detached from the support platform by way of the magnet and magnetizable metal.

6. The tool recited in claim 1, wherein:
the tool includes a support platform with at least one reference hole, and the laser marker includes at least one leg which is inserted into the at least one reference hole to position the laser marker with respect to the support platform.

7. The tool recited in claim 1, wherein:
the laser marker includes a pair of legs extending from a base of the laser marker, the pair of legs being adapted to fit into reference holes in a support platform on the tool to position the laser marker relative to the tool when attached thereto, the laser marker further including a third leg that can be moved between an extended and retracted position, wherein in the extended position the third leg extends from the base to allow the laser marker to stand level on a surface, and when in the retracted position the third leg is recessed within the base.

8. The tool recited in claim 1, further comprising:
a protractor; and
wherein the laser marker is adapted to be releasably and rotatably secured to the protractor, the protractor having indicia thereon to indicate angular measurements and the laser marker being able to rotate relative to the protractor and project a visible line.

9. A tool for cutting workpieces comprising:
a tool having a cutting blade for cutting a workpiece;
a protractor for measuring angles; and
a laser marker for projecting a line onto said workpiece, said laser marker being capable of attaching to both the tool and the protractor.

10. The tool for cutting workpieces of claim 9, wherein:
the tool includes a support platform thereon for releasably securing said laser marker, the support platform aligning the laser marker to the cutting blade and being adjustable relative to the cutting blade for alignment thereto.

11. The tool for cutting workpieces of claim 10, wherein:
the tool is a circular saw having a shoe, and the support platform is located on a front portion of the shoe adjacent the cutting blade.

12. The tool for cutting workpieces of claim 9, wherein:
the tool includes a support platform with one of a magnet or a magnetizable metal, the laser marker includes the other of a magnet or magnetizable metal, and the laser marker being capable of being quickly attached and detached from the support platform by way of the magnet and magnetizable metal.

13. The tool for cutting workpieces of claim 12, wherein:
the laser marker includes a recess formed in its base and the protractor includes a tube extending therefrom, the tube entering the recess to releasably and rotatably hold the laser marker and protractor.

14. The tool for cutting workpieces of claim 13, wherein:
the protractor includes a first and second base surface on opposite sides thereof, a pair of legs extending from the first base surface at a rear portion of the protractor, the pair of legs having alignment surfaces that abut and align the protractor to a workpiece.

15. The tool for cutting workpieces of claim 14, wherein:
the protractor includes indicia on both the first and second base surfaces indicating the relative angles with respect to the alignment surfaces of the protractor.

16. The tool for cutting workpieces of claim 12, wherein:
the support platform includes at least one reference hole, and the laser marker includes at least one leg which is inserted into the at least one reference hole to position the laser marker with respect to the support platform.

17. The tool for cutting workpieces of claim 9, wherein:
the laser marker includes a pair of legs extending from a base of the laser marker and adapted to fit into reference holes in a support platform on the tool to position the laser marker relative to the tool when attached thereto, the laser marker further including a third leg that can be moved between an extended and retracted position wherein in the extended position the third leg extends from the base, and when in the retracted position the third leg is recessed within the base.

18. A method of cutting a workpiece comprising the steps of:
providing a cutting tool and a laser marker, wherein said laser marker is capable of operating independently or in conjunction with said cutting tool;
releasably attaching the laser marker to a shoe of the cutting tool;
activating the laser marker to project a line onto a workpiece; and
cutting the workpiece along the line projected by the laser marker.

19. The method of cutting a workpiece of claim 18, further comprising the step of:
calibrating the laser marker relative to a cutting blade of the cutting tool.

20. The method of cutting a workpiece of claim 19, wherein:
the cutting tool includes a support platform thereon for securing said laser marker, the support platform having lugs extending from opposite sides thereof, the lugs on each side forming a slot through which a fastening member is inserted and secured to the cutting tool, the fastening member being tightened to fixedly secure the support platform to the tool and loosened to release the support platform for calibration relative to the tool.

21. The method of cutting a workpiece of claim 18, wherein:
the tool includes a support platform with one of a magnet or a magnetizable metal, the laser marker includes the other of a magnet or magnetizable metal, and the laser marker is attached to the support platform by way of the magnet and magnetizable metal.

22. The method of cutting a workpiece of claim 18, wherein:
the laser marker includes a pair of legs extending from a base of the laser marker and adapted to fit into reference holes in a support platform on the tool to position the laser marker relative to the tool when attached thereto, the laser marker further including a third leg that can be moved between an extended and retracted position, wherein in the extended position the third leg extends from the base, and when in the retracted position the third leg is recessed within the base.

23. A method of cutting a workpiece, comprising the steps of:
providing a cutting tool, a laser marker and a protractor;
Securing the protractor against a workpiece;
releasably attaching the laser marker to the protractor;
activating the laser marker to project a visible line, and rotating the laser marker relative to the protractor to project the visible line at a desired angle onto the workpiece;
marking the workpiece to indicate the desired angle;
releasably attaching the laser marker to the cutting tool;
activating the laser marker to project a line on a workpiece coincident with the marking; and
cutting the workpiece along the line projected by the laser marker.

24. The method of cutting a workpiece of claim 23, wherein:
the cutting tool includes a support platform with one of a magnet or a magnetizable metal, the laser marker includes the other of a magnet or magnetizable metal, and the laser marker is attached to the support platform by way of the magnet and magnetizable metal.

25. The method of cutting a workpiece of claim 24, wherein:
the one of a magnet or magnetizable metal is located in a base of the laser marker and is recessed therefrom to form a recess, and the protractor includes a support platform having a tube that enters the recess of the laser marker to releasably and rotatably hold the laser marker.

26. The method of cutting a workpiece of claim 25, wherein:
the protractor includes a first and second base surface on opposite sides thereof, a pair of legs extending from the first base surface at a rear portion of the protractor, the pair of legs having alignment surfaces that abut and align the protractor to a workpiece.

27. The method of cutting a workpiece of claim 26, wherein:
the protractor includes indicia on both the first and second base surfaces indicating the relative angles with respect to a rear portion of the protractor.

28. The method of cutting a workpiece of claim 23, wherein:
the laser marker includes a pair of legs extending from a base of the laser marker and adapted to fit into reference holes in a support platform on the tool to position the laser marker relative to the tool when attached thereto, the laser marker further including a third leg that can be moved between an extended and retracted position, wherein in the extended position the third leg extends from the base, and when in the retracted position the third leg is recessed within the base.
